(19) United States
(12) Patent Application Publication
(10) Pub. No.: US 2009/0112613 A1
(43) Pub. Date: Apr. 30, 2009

(54) Business method to improve the internet base on-line dating, chatting and other similar services by adding the process of screening and verification as well as conducting the aforesaid process by person in-person to maximize the value and protection of the service

(76) Inventor: Jay J. Lin, Warren, NJ (US)

Correspondence Address: Jay J. Lin, 19 Deerwood Trail, Warren, NJ, 07059, US

(21) Appl. No.: 12/287,031

(22) Filed: Oct. 6, 2008

Related U.S. Application Data
(60) Provisional application No. 61/000,665, filed on Oct. 26, 2007.

(51) Int. Cl. G06Q 99/00

(52) U.S. Cl. 705/1

(57) ABSTRACT

The Internet based on-line dating, chatting, or other similar services by definition and design allows many participants enter the forum through multiple entry points. Furthermore, by definition and design, information within the forum or platform is exchanged via multiple points.

To ensure the integrity of the Internet based on-line dating, chatting, or other similar services, a screening and verification process is needed to remove the inadvertently errors from entering the system. An in-person by person contact or interview process is needed to minimize the inaccurate and untruthful data that is willfully entered into the services.

By conducting the screening and verification at the entry points in-person by person, this new business method will not only improve but also maximize the value and protection of the services.

This invention is a new business method to improve the Internet based on-line dating, chatting, or other similar services.

The Internet based on-line dating, chatting, or other similar services by definition and design allows many participants enter the forum through multiple entry points. Furthermore, by definition and design, information within the forum or platform is exchanged via multiple points.

In a perfect world, the integrity of the on-line dating, chatting, or other similar services can be achieved if all the participants from various entry points input only accurate and truthful data. Unfortunately, inaccurate and untruthful data inadvertently and willfully enter the system. The system is therefore often corrupted.

To ensure the integrity of the Internet based on-line dating, chatting, or other similar services, a screening and verification process is needed to remove the inadvertently errors from entering the system. An in-person by person contact or interview process is needed to minimize the inaccurate and untruthful data that is willfully entered into the services.

The invention is adding a new process in the Internet based on-line dating, chatting, or other similar services, which involves a group of large amount of participants entering the forum created or defined by the creator to serve or perform various purposes.

The invention here is adding the process of performing a screening and verification process at the entry point of the forum or platform to ensure the retrieval will therefore be truthful.

The invention here is also adding the screening and verification process to be conducted in-person by person. The identity of a person in some cases can only be achieved by person in-person contact or interview.

By conducting the screening and verification at the entry points in-person by person, this new business method will not only improve but also maximize the value and protection of the services.

1. The invention claims the process of perform a screening and verification at the entry points of the Internet based on-line dating, chatting, or other similar services to ensure the integrity of the services.

2. The invention claims the process of perform a screening and verification for Internet based on-line dating, chatting, or other similar services to be conducted in person by person to verify the true identities of the participants.
